(19) United States
(12) Patent Application Publication
(10) Pub. No.: US 2010/0283178 A1
(43) Pub. Date: Nov. 11, 2010

(54) PROCESS FOR PRODUCING SOFT CAPSULE SHELLS BASED ON POLYVINYL ALCOHOL-POLYETHYLENE GLYCOL GRAFT COPOLYMERS

(75) Inventor: Karl Kolter, Limburgerhof (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/066,329

(22) PCT Filed: Aug. 31, 2006
(86) PCT No.: PCT/EP2006/065865

§ 371 Date: Mar. 10, 2008

(30) Foreign Application Priority Data
Sep. 9, 2005 (DE) 102005043172.0

(51) Int. Cl. B29C 47/88

(52) U.S. Cl. 264/211.12

(57) ABSTRACT

A process for producing gelatin-free soft capsule shells based on polyvinyl alcohol-polyether graft copolymers as shell polymers, which comprises heating an aqueous solution comprising at least 45% by weight, based on the total weight of the solution, of a polymer component, where the polymer component consists of a polyvinyl alcohol-polyether graft copolymer or a mixture of polyvinyl alcohol-polyether graft copolymers and polyvinyl alcohol, extruding the solution at a temperature of at least 70° C., and solidifying the resulting film by cooling.

The present invention relates to an improved process for producing soft capsule shells based on polyvinyl ester-polyethylene glycol graft copolymers.

Soft capsules are distinguished by the fact that the production of the shell and the filling take place virtually simultaneously in one step. The shell of such soft capsules ordinarily consists mainly of gelatin, which is why the capsules are often also referred to as soft gelatin capsules. Since gelatin is per se a brittle material of low flexibility, it must be plasticized appropriately, i.e. plasticizers must be added. Such plasticizers are low molecular weight compounds, ordinarily liquids such as, for example, glycerol, propylene glycol, polyethylene glycol 400. Such capsules often additionally comprise dyes, opacifying agents and preservatives.

Although gelatin is frequently employed, it has numerous disadvantages. Thus, gelatin is a material of animal origin and thus not kosher. In addition, there is always a slight residual risk of BSE, because gelatin from cattle is preferably used to produce it. Obtaining suitable gelatin is very complicated and requires strict supervision of the process. Despite this, differences between batches are large because of the animal origin, which is subject to a certain variability. Gelatin is very susceptible to microbes because it represents a good nutrient medium for microorganisms. It is therefore necessary to take appropriate measures during the production as well as the use of such packaging materials. The use of preservatives is frequently indispensable.

The plasticizers which are absolutely necessary to produce gelatin capsules frequently migrate from the shell into the filling and cause changes there. The shell loses plasticizers and becomes brittle and mechanically unstable during the course of storage. In addition, the shell of a soft gelatin capsule has a relatively high water content, which likewise has a plasticizing effect. On storage of such capsules with pure humidity there is evaporation of water from the shell, which likewise makes the capsule brittle. The same thing happens when very hygroscopic materials are encapsulated. Particularly hygroscopic or hydrolysis-sensitive substances cannot be encapsulated at all.

The rate of dissolution of gelatin is relatively slow. A higher rate of dissolution in gastric or intestinal fluid would be desirable for rapid release of active ingredients.

Numerous substances lead to interactions with gelatin, such as, for example, aldehydes, polyphenols, reducing sugars, multiply charged cations, electrolytes, cationic or anionic polymers etc., with crosslinking frequently occurring and the capsule then disintegrating or dissolving only very slowly or not at all. Such changes are catastrophic for a drug product because efficacy is lost. Many drugs also lead to interactions with gelatin. In some cases during storage there is formation of drug degradation products with, for example, an aldehyde structure, which lead to cross-linking of the gelatin. Since gelatin has both acidic and basic groups, it is clear that reactions easily occur with other charged molecules.

Gelatin can be cleaved by enzymes. Contamination by enzymes or enzymes released by bacteria may drastically alter the properties of gelatin.

Soft gelatin capsules very readily stick together under warm and moist conditions.

The adhesion of film coatings to soft gelatin capsules is extremely poor. For them it is frequently necessary first to apply a special subcoating, which is inconvenient.

Because of these many disadvantages, there has been no lack of attempts to replace gelatin wholly or partly in soft capsules.

Thus, for example, U.S. Pat. No. 6,340,473 describes soft capsules based on modified starches and carrageenans.

For example, polyvinyl alcohol has been described for this purpose. However, polyvinyl alcohol has a slow rate of dissolution, likewise requires additional plasticizers, which in turn may migrate and which, as described above, may alter the properties of the filling, and it may moreover become extremely brittle as a consequence of internal crystallization. In particular, the flexibility decreases drastically during the course of storage if the ambient humidity is low.

DE-A2 2 363 853 describes the use of partially hydrolyzed copolymers of vinyl acetate on polyethylene glycol for producing hard capsules for medicines. There are no references in this publication to the use of the copolymers for producing soft capsules.

However, the requirements to be met by hard capsules are quite different from those for soft capsules. Hard capsules require great strength, while flexibility is a priority with soft capsules. The production processes also differ entirely. In the case of hard capsules, firstly only the shell is produced in 2 separate parts, a cap and a body, by a dip process, whereas in the case of soft capsules the shell and the filling are produced virtually simultaneously.

In the case of hard capsules, after production of cap and body these are loosely fitted together so that the pharmaceutical manufacturer is able to separate the two parts again mechanically, introduce his powder and close the capsule. Detailed examination of this processing makes it clear that the two capsule parts must be very mechanically stable, especially since the filling machines operate very rapidly and changes in shape would bring the entire process to a stop.

In the case of soft capsules, the shell must firstly be absolutely leakproof so that the filling, which is usually liquid, cannot escape, and secondly very flexible because the filling would otherwise escape through cracks or microfissures. Particularly high flexibility is necessary for production because the polymer film is sucked into drilled cavities and is thus greatly deformed and stretched. The production of soft capsules is a technologically very demanding process, which is why the polymer properties and the machines must be harmonized and adjusted accurately.

The entirely different processes for producing hard and soft gelatin capsules are described in W. Fahrig and U. Hofer, Die Kapsel, Wissenschaftliche Verlagsgesellschaft mbH Stuttgart, 1983, pp. 58-82.

The application WO 97/35537 describes a special process for producing soft capsules using various materials, mainly polyvinyl alcohol. Before the encapsulation, a solvent is applied to the film to partly dissolve it so that better adhesion can be achieved. However, this is necessary only for films which are correspondingly difficult to process.

DE 1 094 457 and DE 1 081 229 describe processes for producing graft copolymers of polyvinyl alcohol on polyalkylene glycols by hydrolyzing the vinyl esters and the use thereof as protective colloids, water-soluble packaging films, as sizing and finishing agents for textiles and in cosmetics.

WO 99/40156 describes combinations of polyethylene glycols of various molecular weights which are suitable for producing films or soft capsules. However, polyethylene glycols with a high molecular weight dissolve only slowly in water and are brittle. Although combination with polyethylene glycols with a very low molecular weight makes them somewhat more flexible, they also become more tacky. In addition, they may in turn migrate into the filling because of their low molecular weight.

U.S. Pat. No. 3,984,494 describes polyvinyl alcohol-polyether graft copolymers for producing hard capsules.

EP-A 1136070 describes soft capsules composed of polyvinyl alcohol-polyether graft copolymers. The capsule shells are produced by the polymers first being dissolved in water and then drawn out to films. However, the films obtained in this way still leave room for improvements in relation to their strength and processability.

It was an object of the present invention to find an improved process for producing soft capsule shells.

We have accordingly found a process for producing soft capsule shells based on polyvinyl alcohol-polyether graft copolymers, which comprises extruding an aqueous solution comprising at least 45% by weight of a polymer component which consists of polyvinyl alcohol-polyether graft copolymer or of a mixture of the polyvinyl alcohol-polyether graft copolymer with polyvinyl alcohol, at a temperature of at least 70° C., and solidifying the extrudates to films by cooling.

Preferred graft copolymers processed according to the invention are obtainable by free-radical polymerization of

a) 10 to 98% by weight of at least one vinyl ester of
C₁-C₂₄ carboxylic acids in the presence of
   b) 2 to 90% by weight of at least one polyether-containing compound and
   subsequently hydrolysis of the ester groups.

Polymers which are particularly preferably processed are obtainable by free-radical polymerization of

a) 50 to 97% by weight of at least one vinyl ester of
C₁-C₂₄ carboxylic acids in the presence of
   b) 3 to 50% by weight of at least one polyether-containing compound.

Polymers which are very particularly preferably processed are obtainable by free-radical polymerization of
a) 65 to 97% by weight of at least one vinyl ester of C₁-C₂₄ carboxylic acids in the presence of
b) 3 to 35% by weight of at least one polyether-containing compound and
   vinyl acetate is preferably employed as vinyl ester.

The molecular weight of the polyethers is in the range below 500 000 (number average), preferably in the range from 300 to 100 000, particularly preferably in the range from 500 to 50 000, very particularly preferably in the range from 1000 to 20 000.

It is advantageous to use homopolymers of ethylene oxide or copolymers with an ethylene oxide content of from 40 to 99% by weight. Thus, the content of ethylene oxide units in the ethylene oxide polymers to be preferably employed is from 40 to 100 mol %. Suitable comonomers for these copolymers are propylene oxide, butylene oxide and/or isobutylene oxide. Suitable examples are copolymers of ethylene oxide and propylene oxide, copolymers of ethylene oxide and butylene oxide, and copolymers of ethylene oxide, propylene oxide and at least one butylene oxide. The ethylene oxide content of the copolymers is preferably from 40 to 99 mol %, the propylene oxide content is from 1 to 60 mol % and the content of butylene oxide in the copolymers is from 1 to 30 mol %. Not only straight-chain but also branched homo- or copolymers can be used as polyether-containing compounds b).

To prepare the graft polymers used according to the invention, the ester groups of the original monomers a) and, if appropriate, other monomers are cleaved after the polymerization by hydrolysis, alcoholysis or aminolysis. This process step is generally referred to as hydrolysis hereinafter. The hydrolysis takes place in a manner known per se by adding a base, preferably by adding a sodium or potassium hydroxide solution in water and/or alcohol. Methanolic sodium or potassium hydroxide solutions, and sodium and potassium methanolate solutions are particularly preferably employed. The hydrolysis is carried out at temperatures in the range from 10 to 80° C., preferably in the range from 20 to 60° C. The degree of hydrolysis depends on the amount of base employed, on the hydrolysis temperature, the hydrolysis time and the water content of the solution.

The degree of hydrolysis of the polyvinyl ester groups is in the range from 50 to 100%, preferably in the range from 60 to 100%, and particularly preferably in the range from 80 to 100%.

It is possible in particular with the aid of the process of the invention to process a graft copolymer which has been obtained by polymerization of 15% by weight of polyether portion and 85% by weight of vinyl acetate. The molecular weight of the polyether component in this case is preferably 6000 dalton. The degree of hydrolysis is preferably 88-98%.

The soft capsule shells may comprise polyvinyl alcohol as further polymer component. Polyvinyl alcohols having average molecular weights M_{w} of from 1000 to 500 000, preferably 5000 to 100 000 and particularly preferably 10 000 to 50 000 are preferably employed. The ratio of polyvinyl ester-polyether graft copolymer to polyvinyl alcohols can be from 100:0 to 30:70, preferably 100:0 to 50:50, by weight.

The process of the invention is carried out by firstly preparing a solution of the graft copolymers or of the mixture of graft copolymer with the polyvinyl alcohol and, if appropriate, further auxiliaries, the solids content of the solution being chosen so that the content of graft copolymers or of the total of graft copolymers and polyvinyl alcohol is at least 45% by weight and up to 75% by weight, preferably 50 to 70% by weight, based on the total weight of the aqueous solution. The solution is brought before the extrusion to a temperature of at least 70° C. and up to 120° C., preferably 75 to 100° C. The hot solution is then discharged and, after cooling, a film produced.

Apparatuses suitable for carrying out the process are conventional extruders. Also suitable is any other apparatus which is designed for processing hot liquids and includes a pump or other conveying units in order to force the hot polymer-containing liquid under pressure through a suitable die device. It is possible to use for this purpose all conventional pumps and conveying units capable of pulsation-free conveying.

The process of the invention can preferably be carried out with the aid of an extruder. In principle, the conventional types of extruder known to the skilled worker are suitable for the process of the invention. These ordinarily comprise a housing, a drive unit and a plastifying or mixing unit composed of one or more rotating shafts provided with conveying or mixing elements (screws).

Along the screws in the direction of transport there is a plurality of sections which comprise in the process of the invention a feed zone, a mixing zone and a metering zone. It is also possible if desired to provide devolatilizing zones where the devolatilization can take place under atmospheric pressure and/or vacuum. Vacuum devolatilization can take place for example with the aid of a stuffing screw and a steam-jet pump.

Each of these sections may in turn comprise one or more barrels (sections) as smallest independent unit.

The solution to be extruded can be produced in a single-screw extruder, a twin-screw extruder or in multiple screw extruders, but preferably in a twin-screw extruder. Two or more screws may be designed to corotate or counterrotate, with intermeshing or with close intermeshing. The extruder is preferably designed for closely intermeshing corotation. The individual barrels should be heatable.

The screws may be constructed from all the elements usual in extrusion. They may besides conventional conveying elements also comprise kneading discs or reverse-conveying elements in order to ensure optimal mixing of the components. The screw configuration suitable in the individual case can be established by the skilled worker through simple tests. The ratio of screw length to screw diameter (LD ratio) can be from 20:1 to 40:1, preferably 24:1 to 36:1.

The extruder used according to the invention is essentially divided into the following sections:

A first zone serves as back-venting zone in order to make it possible to remove the air carried in with the powdered polymer component. In a second zone, the polymer component is metered by means of suitable metering devices such as, for example, weigh feeders into the extruder. This zone can be followed by a conveying zone in which the polymer component can be initially heated if desired. This is followed by a zone in which water and, if appropriate, further liquid components are metered in via piston or gear pumps. In the subsequent zones there is intensive mixing of the components. These zones are preferably equipped with kneading discs in order to ensure sufficiently thorough mixing. All the zones are heatable. A jacket temperature of from 90 to 120° C. is normally chosen. The extrusion pressure set up is in the range from 0.05 to 0.2 MPa.

The hot polymer solution is discharged as described through a suitable die. Discharge is possible for example through a pipe die or, preferably, through a slot die. If pipe dies are used, the emerging extrudate can subsequently be shaped by knife application or with the aid of rolls.

Slot dies for producing films are known per se. Suitable slot heights have a slot diameter of from 100 to 2000 μm, preferably from 150 to 1000 μm.

After leaving the slot die, the films are transported further by a moving conveyor belt or rolls. During this, the extrudates are solidified by cooling. This entails reducing the temperature of the extrudate by at least 10° C. in order to achieve solidification to films. The cooling of the films can be effected by an appropriate cooling of the conveyor belt or else by cold air which is passed over the film. It is also possible to combine the two techniques together. Suitable film thicknesses are between 100 and 2000 μm, preferably between 150 and 1000 μm.

The films produced according to the invention and suitable as soft capsule shells have the following properties in particular:

Elongation at break: 50-600% in the moist state
25-300% in the dry state (at an equilibrium humidity of 53% relative humidity.)
   Tensile strength: 2-30 N/mm² in the moist state
5-60 N/mm² in the dry state (at an equilibrium humidity of 53% relative humidity)

Besides the polyvinyl alcohol-polyether graft copolymers and, if appropriate, the polyvinyl alcohol, further auxiliaries may also be added to the solutions used to produce the soft capsule shells.

Thus, from 0.1 to 30% by weight, based on the total weight of the solutions, of plasticizers, for example glycerol, 1,2 propylene glycol or polyethylene glycol with molecular weights of between 250 and 600 can be added to the solutions.

To achieve resistance to gastric fluid it is possible for the shell to comprise from 20 to 80%, preferably 30 to 70%, of a polymer resistant to gastric fluid.

It is possible to add to the polymers structure-improving auxiliaries in order to modify the mechanical properties such as flexibility and strength. These structure-improving auxiliaries can be divided into 2 large groups.
A) Polymers with a molecular weight of more than 50 000, preferably more than 100 000
B) substances leading to crosslinking of the polymer chains, either of the polymers or of the substances mentioned under A), preferably aldehydes, boric acid and its salts,
   and, if appropriate, substances which lead to crosslinking of the polymer chains of the structure-improving auxiliaries, preferably alkaline earth metal ions, amines, tannins, and aldehydes and borates.

High molecular weight polymers which can be employed are substances from the following classes:

polyamino acids such as gelatin, zein, soybean protein and derivatives thereof,
polysaccharides such as starch, degraded starch, maltodextrins, carboxymethylstarch, hydroxypropylstarch, cellulose, hydroxypropylmethylcellulose, hydroxypropylcellulose, hydroxyethylcellulose, methylcellulose, carboxymethylcellulose, ethylcellulose, cellulose acetate, cellulose acetate phthalate, hydroxypropylcellulose acetate phthalate, hydroxypropylcellulose acetate succinate, hemicellulose, galactomannans, pectins, alginates, carrageenans, xanthan, gellan, dextran, curdlan, pullulan, chitin, and derivatives thereof, synthetic polymers such as polyacrylic acid, polymethacrylic acid, copolymers of acrylic esters and methacrylic esters, polyvinyl acetate, polyethylene glycols, polyoxyethylene/polyoxypropylene block copolymers, polyvinylpyrrolidones and derivatives thereof.

These high molecular weight polymers form a network with the polymers and thus increase the strength of the soft capsules. The flexibility is usually not compromised as long as the concentrations used are not very high. Surprisingly, not only water-soluble but also water-insoluble polymers such as copolymers of acrylic esters and methacrylic esters are suitable for this purpose. The capsules still disintegrate as long as the concentration of these water-insoluble polymers remains below 50%.

Preferred structure-improving auxiliaries are carrageenans, modified starches such as hydroxypropyl starch or cellulose derivatives such as hydroxypropylcellulose.

Substances which lead to crosslinking either of the polymer chains of the polymers or of the added high molecular weight polymers act in a similar way.

Besides the components mentioned, it is possible for the soft capsule shells according to the invention to comprise other conventional constituents. These include fillers, release agents, flow aids, stabilizers and water-soluble or water-insoluble dyes, flavorings and sweeteners.

Examples of dyes are iron oxides, titanium dioxide, which are added in an amount of about 0.001 to 10, preferably of 0.5 to 3, % by weight, triphenylmethane dyes, azo dyes, quinoline dyes, indigo dyes, carotenoids, in order to color the capsules, opacifying agents such as titanium diodide or talc in order to decrease the transparency and save on dyes.

Flavorings and sweeteners are particularly important when an unpleasant odor or taste is to be masked and the capsule is chewed.

Preservatives are usually unnecessary.

Examples of fillers are inorganic fillers such as oxides of magnesium, aluminum, silicon, titanium or calcium carbonate. The preferred concentration range for the fillers is about 1 to 50% by weight, particularly preferably 2 to 30% by weight, based on the total weight of all the components.

Lubricants are stearates of aluminum, calcium, magnesium and tin, and magnesium silicate, silicones and the like. The preferred concentration range is about 0.1 to 5% by weight, particularly preferably about 0.1 to 3% by weight, based on the total weight of all the components.

Examples of flow aids are fine-particle or extremely fine-particle silicas, modified if appropriate. The preferred concentration range is 0.05 to 3% by weight, particularly preferably 0.1 to 1% by weight, based on the total weight of all the components.

The incorporation of active ingredients into the shell represents a special case. This may be advantageous for separating incompatible active ingredients from one another. The active ingredient with the smallest dose should then be incorporated into the shell.

The soft capsule shells obtained according to the invention consist of from 10 to 100%, preferably 20 to 98%, of polymers, if appropriate from 0 to 80%, preferably 1 to 50%, of structure-improving auxiliaries and, if appropriate, from 0 to 30%, preferably 0.1 to 30%, of other conventional constituents.

The filled soft capsules can be produced by processes known per se for producing soft capsules, for example the rotary die process, the Accogel process, the Norton process, the drop or blow process or by the Colton-Upjohn process. These processes are described in W. Fahrig and U. Hofer, Die Kapsel, Wissenschaftliche Verlagsgesellschaft mbH Stuttgart, 1983.

Before the processing in the encapsulation unit, the films obtained according to the invention and suitable as soft capsule shells can be moistened if desired with water or with water-miscible organic solvents or with mixtures of water and water-miscible solvents. Suitable water-miscible solvents are: glycerol, 1,2-propylene glycol, polyethylene glycol with molecular weights of between 250 and 600. This is particularly advisable when the film used for encapsulation is insufficiently soft and tacky and thus sealing is difficult. Superficial application of these substances softens the film and improves sealability. Application is possible by spraying on, roller application, brushing on or knife application.

The particular advantages of the described capsules and of the described process are that the processing times for producing the films are very short (only a few minutes) and the films comprise hardly any air bubbles. The short production time makes it possible to adapt the speed of film production to the speed of encapsulation. Film production and encapsulation thus take place in a completely continuous process. This is not possible by using the process of film casting from polymer solutions. In this case it is necessary for the polymer solution first to be prepared, applied by knife and dried.

The process of the invention makes it possible further to adjust the water content easily and individually virtually without any restriction due to high viscosities. It is thus possible to adjust very high solids contents. By contrast, knife application of films is possible only with low-viscosity solutions. The smaller amount of water which must be evaporated results in a considerably more favorable energy balance in the process of the invention.

The sealing can likewise take place at high speed very uniformly and reproducibly and without fissures or pores, and thus extremely few damaged capsules are rejected. In addition, the capsules are easy to dry, retain their shape and flexibility during this and are stable on storage because they do not, like, for example, starch, show the phenomenon of retrogradation. The rate of dissolution of the shell is greater than for known capsules and, in particular, they dissolve even in cold aqueous media.

Typical packaged materials are preferably pharmaceutical products such as solid and liquid active ingredients, but also vitamins, carotenoids, minerals, trace elements, food supplements, spices and sweeteners. The capsules can also be used for cosmetic active ingredients (personal care), such as, for example, hair and skin formulations, for oils, perfumes, bath additives or proteins. Further applications in the personal care sector, and further applications for water-soluble packagings are mentioned in WO 99/40156.

Further possible examples of such packaged materials are cleaners, such as soaps, detergents, colorants and bleaches, agrochemicals such as fertilizers (or combinations thereof), crop protection agents such as herbicides, fungicides or pesticides, and seeds.

It is possible in general to package contents which are to be protected before they are brought into a wet environment.

The soft capsules having the composition of the invention and obtained according to the invention are excellently suited for coating by use of aqueous polymer solutions or polymer suspensions. Thus, a coating which is resistant to gastric juice and adheres strongly to the surface and, moreover, is stable on storage can be applied by spraying on Kollicoat MAE 30 DP (methacrylic acid copolymer type C of USP) in a horizontal drum coater.

### EXAMPLES

The following graft copolymers can be processed by the process of the invention:

### General Production Method:

The polyether-containing compound is introduced into a polymerization vessel and heated to 80° C. while stirring under a gentle stream of nitrogen. Vinyl acetate and the further monomer are metered in while stirring in 3 h. At the same time, a solution of 1.4 g of tert-butyl perpivalate in 30 g of methanol is likewise added in 3 h. Stirring is then continued at 80° C. for 2 h. After cooling, the polymer is dissolved in 450 ml of methanol. For the hydrolysis, 50 ml of a 10% strength methanolic sodium hydroxide solution are added at 30° C. After 40 min, the reaction is stopped by adding 750 ml of 1% strength acetic acid. The methanol is removed by distillation.

The K values were determined on 1% solutions in N-methylpyrrolidone.

| | | | | Degree of |
|---|---|---|---|---|
| Polymer | Grafting base | Vinyl ester | K value | hydrolysis [%] |
| 1 | PEG 1500¹ | Vinyl acetate, | 47 | >96 |
| | 72 g | 410 g | | |
| 2 | PEG 4000 | Vinyl acetate, | 51 | >96 |
| | 72 g | 410 g | | |
| 3 | PEG 6000, | Vinyl acetate, | 54 | 95 |
| | 72 g | 410 g | | |
| 4 | PEG 6000, | Vinyl acetate, | 49 | 96 |
| | 137 g | 410 g | | |
| 5 | PEG 6000, | Vinyl acetate | 73 | 94 |
| | 22 g | 410 g | | |
| 6 | PEG 6000, | Vinyl acetate | 42 | 96 |
| | 410 g | 410 g | | |
| 7 | PEG 9000, | Vinyl acetate, | 58 | 97 |
| | 137 g | 410 g | | |
| 8 | Polyglycerol 2200, | Vinyl acetate, | 66 | 96 |
| | 72 g | 410 g | | |
| 9 | PEG-PPG block | Vinyl acetate, | 45 | 96 |
| | copolymer 8000², | 410 g | | |
| | 72 g | | | |
| 10 | Methylpolyethylene | Vinyl acetate, | 47 | 97 |
| | glycol 2000³ | 410 g | | |
| | 72 g | | | |
| 11 | Alkylpolyethylene | Vinyl acetate, | 48 | 98 |
| | glycol 3500⁴ | 410 g | | |
| | 72 g | | | |
| 12 | PPG 4000⁵ | Vinyl acetate | 50 | 92 |
| | 72 | 410 g | | |
| 13 | PEG 20000 | Vinyl acetate, | 69 | 96 |
| | 72 g | 410 g | | |
| 14 | PEG 20000 | Vinyl acetate, | 64 | 94 |
| | 103 g | 410 g | | |
| 15 | PEG 20000 | Vinyl acetate, | 59 | 95 |
| | 137 g | 410 g | | |
| 16 | PEG 20000 | Vinyl acetate, | 55 | 86 |
| | 615 g | 410 g | | |
| 17 | PEG 35000 | Vinyl acetate, | 77 | 95 |
| | 72 g | 410 g | | |
| 18 | PEG 35000 | Vinyl acetate, | 80 | 95 |
| | 137 g | 410 g | | |
| 19 | PEG 35000 | Vinyl acetate, | 65 | 97 |
| | 205 g | 410 g | | |
| 28 | PEG 35000, | Vinyl acetate, | 59 | 96 |
| | 270 g | 410 g | | |

¹PEG x: Polyethylene glycol of average molecular weight x
²Lutrol F 68 from BASF Aktiengesellschaft (PPG: Polypropylene glycol)
³Pluriol A 2000 E from BASF Aktiengesellschaft
⁴Lutensol AT 80 from BASF Aktiengesellschaft (C₁₆-C₁₈ fatty alcohol + 80 EO)
⁵Polypropylene glycol of average molecular weight 4000

### General Method for Producing Soft Capsule Shells:

Processing took place in a Coperion Werner & Pfleiderer ZSK 25 twin-screw compounder having 8 barrels with a screw diameter of 25 mm and an L/D ratio of 34:1. The barrel temperature was 90 to 120° C., and the screw rotated at 120 to 150 rpm.

The polymers were fed into barrel 2 in the extruder and heated gently. The appropriate amounts of water and plasticizer were metered through injector nozzles into barrel 4, and the mixture was heated to 97° C. to dissolve the polymers. Extrusion took place at a die temperature of 93° C. through a slot die with a width of 100 mm and a height of 600 μm. The emerging films were cooled to 47° C.

The processing time for producing the films was 4 min (dissolving the polymer and extruding the films: 2 min, cooling the films 2 min).

The films comprised no air bubbles.

The composition of the individual films is listed in the table below.

Graft copolymer 3 was used as polymer A.

A mixture of graft copolymer 3 and polyvinyl alcohol (M_{w} 37 000) in the ratio 6:4 by weight was used as polymer B.

| Example | Composition of extrusion solution | | |
|---|---|---|---|
| No. | Polymer/[wt. %] | Water [wt. %] | Auxiliary/[wt. %] |
| 1 | A/45 | 55 | 0 |
| 2 | A/50 | 50 | 0 |
| 3 | A/45 | 47.5 | Glycerol/7.5 |
| 4 | B/50 | 45 | Glycerol/5 |
| 5 | B/56 | 38 | Glycerol/6 |
| 6 | B/50 | 35 | Glycerol/15 |
| 7 | B/58 | 37 | Glycerol/5 |
| 8 | A/50 | 45 | Carrageenan/5 |
| 9 | B/50 | 45 | Hydroxypropylstarch/5 |
| 10 | A/45 | 55 | HPC/5 |

### Production of Soft Capsules

The films of examples 1-1.0 were processed to oval soft capsules 10 minims in size by the rotary die process. Tocopherol acetate was used as capsule filling in a dosage of 500 mg. The capsules were collected in a drum and dried at 35° C. for 24 h.

Less than 1% of capsules were rejected for unsatisfactory sealing during the encapsulation.

### COMPARATIVE EXAMPLE

1.0 kg of polyethylene glycol 6000/polyvinyl acetate (15:85) hydrolyzed polymer, prepared as disclosed in EP 1136070, were dissolved in 1.5 kg of demineralized water, and the solution was heated to 60° C. and drawn out to a 300 μm-thick film and dried at 60° C. Soft gelatin capsules likewise with 500 mg of tocopherol acetate were produced from this film by the rotary die process.

The processing time for producing the film was 125 min (dissolving the polymer: 45 min, substantial removal of air bubbles: 60 min, film-drawing and drying: 20 min).

The capsule shell still comprised visible air bubbles.

11% of capsules were rejected for unsatisfactory sealing.

1. A process for producing gelatin-free soft capsule shells based on polyvinyl alcohol-polyether graft copolymers as shell polymers, which comprises heating an aqueous solution comprising at least 45% by weight, based on the total weight of the solution, of a polymer component, where the polymer component consists of a polyvinyl alcohol-polyether graft copolymer or a mixture of polyvinyl alcohol-polyether graft copolymers and polyvinyl alcohol, extruding the solution at a temperature of at least 70° C., and solidifying the resulting film by cooling.

2. The process according to claim 1, wherein further auxiliaries are additionally added to the aqueous solution.

3. The process according to claim 1, wherein the ratio of polyvinyl alcohol-polyether graft copolymer to polyvinyl alcohol is from 100:1 to 30:70 by weight.

4. The process according to claim 1, wherein starch derivatives, cellulose derivatives or carrageenans are employed as further auxiliaries.

5. The process according to claim 1, wherein plasticizers are employed as further auxiliaries.

6. The process according to claim 1, wherein the aqueous solution is produced in an extruder.

7. The process according to claim 1, wherein the aqueous solution of the polymer component has been extruded through a slot die.

8. The process according to claim 1, wherein the films obtained after the cooling are moistened with water, with a water-miscible organic solvent or with a mixture of water and a water-miscible organic solvent before introduction into the encapsulation unit.

9. The process according to claim 1, wherein the extrudates are solidified by cooling to a temperature which are at least 10° C. below the extrusion temperature.

10. The process according to claim 2, wherein the ratio of polyvinyl alcohol-polyether graft copolymer to polyvinyl alcohol is from 100:1 to 30:70 by weight.

11. The process according to claim 2, wherein starch derivatives, cellulose derivatives or carrageenans are employed as further auxiliaries.

12. The process according to claim 3, wherein starch derivatives, cellulose derivatives or carrageenans are employed as further auxiliaries.

13. The process according to claim 2, wherein plasticizers are employed as further auxiliaries.

14. The process according to claim 3, wherein plasticizers are employed as further auxiliaries.

15. The process according to claim 4, wherein plasticizers are employed as further auxiliaries.

16. The process according to claim 2, wherein the aqueous solution is produced in an extruder.

17. The process according to claim 3, wherein the aqueous solution is produced in an extruder.

18. The process according to claim 4, wherein the aqueous solution is produced in an extruder.

19. The process according to claim 5, wherein the aqueous solution is produced in an extruder.

20. The process according to claim 2, wherein the aqueous solution of the polymer component has been extruded through a slot die.
